(19) United States
(12) Patent Application Publication
(10) Pub. No.: US 2019/0291052 A1
(43) Pub. Date: Sep. 26, 2019

(54) BACTERIA MICROTRAPS

(71) Applicants: CALIFORNIA INSTITUTE OF TECHNOLOGY, Pasadena, CA (US); ETH Zuerich, Zuerich (CH)

(72) Inventors: Chiara DARAIO, South Pasadena, CA (US); Raffaele DI GIACOMO, Zurich (CH); Roman STOCKER, Zurich (CH)

(21) Appl. No.: 16/294,855

(22) Filed: Mar. 6, 2019

Related U.S. Application Data
(60) Provisional application No. 62/645,628, filed on Mar. 20, 2018.

(51) Int. Cl. B01D 61/00; B01D 61/14; B01D 61/18; B01D 21/00

(52) U.S. Cl. CPC B01D 61/007; B01D 61/147; B01D 21/0084; B01D 21/0042; B01D 21/0069; B01D 61/18

(57) ABSTRACT

Microstructures immersed in a liquid have multiple chambers and funnels oriented inwardly. The funnels generate differential motility for bacteria. Bacteria is therefore concentrated within the chamber, and effectively sequestered from the environment outside the microstructures. Multiple consecutive chambers and conical funnels allow more effective sequestration of bacteria. These microtraps offer biocontrol options alternative to pharmaceutical solution such as antibiotics.

### CROSS REFERENCE TO RELATED APPLICATIONS

The present application claims priority to U.S. Provisional Patent Application No. 62/645,628, filed on Mar. 20, 2018, the disclosure of which is incorporated herein by reference in its entirety.

### TECHNICAL FIELD

The present disclosure relates to bacteria removal. More particularly, it relates to deployable microtraps to sequester motile bacteria.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates an example of deployable micro-traps.

FIG. 2 illustrates an exemplary embodiment of a microtrap comprising multiple funnels oriented in opposite directions.

FIG. 3 illustrates a scanning electron microscope of a microtrap.

FIG. 4 illustrates an SEM picture of an array of microtraps.

FIG. 5 illustrates four different geometries for microtraps.

FIG. 6 illustrates data for each of the structures of FIG. 5.

FIGS. 7-9 illustrate bacterial depletion with deployable micro-traps, from experiments and numerical simulations.

FIG. 10 illustrates a close up view of a funnel aperture.

FIG. 11 illustrates a simulation of the trapping capabilities of the surface bound micro-traps.

FIG. 12 shows the deployable micro-trap with cylindrical apertures.

FIG. 13 illustrates numerical simulations of 2D cross-sections of deployable micro-traps.

### SUMMARY

In a first aspect of the disclosure, a microtrap is described, the microtrap: an outer surface separating an inner volume of the microtrap from an outer volume; and at least one opening allowing entry of motile bacteria from the outer volume into the inner volume.

### DETAILED DESCRIPTION

The development of strategies to reduce the load of unwanted bacteria is a fundamental challenge in industrial processing, environmental sciences and medical applications. The present disclosure describes methods to sequester motile bacteria from a liquid, based on passive, deployable micro-traps that confine bacteria. The microtraps use micro-funnels that open into trapping chambers. Even in low concentrations, micro-traps afford a 70% reduction in the amount of bacteria in a liquid sample, with a potential to reach a reduction greater than 90%, as shown by modelling improved geometries. The present disclosure describes a new approach to contain the growth of bacteria without chemical means, an advantage of particular importance given the alarming growth of pan-drug-resistant bacteria.

Existing approaches to restrict the presence of bacteria in an environment are known to have important limitations. For example, antibacterial agents, or antibiotics, interfere with bacteria's biochemical or genetic processes, but their excessive use poses serious concerns related to the emergence of pan-drug resistant strains. Other methods to limit bacterial growth are based on the application of high temperatures, or high energy irradiation. For example, pasteurization is an effective, widespread method, but creates undesired free radicals and thermolytic byproducts. Gamma ray irradiation treatments require expensive equipment and a source of radiation. Microfiltration and sonication require considerable external energy. As these approaches are often invasive and expensive, the development of alternative or complementary strategies to reduce bacterial loads will be extremely beneficial in a broad field of applications.

The present disclosure describes how to exploit the bacteria's dynamic behavior to control the load of bacteria in liquid environments, by leveraging their motility and interaction with surfaces to trap them into microscale engineered particles. Key human pathogens, such as Salmonella enterica, Helicobacter pylori, Vibrio cholerae, Vibrio vulnificus, Pseudomonas aeruginosa, and virulent strains of Escherichia coli are motile: they use their flagella to reach specific niches in the host. For example, Salmonella—which is found in contaminated food and water and represents the causative agent of gastroenteritis—swims towards and adheres to gastro-intestinal villi before entering the intestinal cells. Enterobacteriaceae in general, live in close association with surfaces. These surfaces can generate attractive hydrodynamic forces on swimming bacteria (swimmers), resulting in their accumulation in the proximity of boundaries. The attractive forces between bacteria and surfaces provide specific tropism to the target site on the intestinal cell's surface, thus permitting the pre-docking phase at the onset of infection.

Understanding of how bacteria move and interact with surfaces has, over the last decade, been significantly furthered by the advances in microfabrication techniques. For example, the effect of surfaces in redirecting bacteria has been exploited in the design of two-dimensional (2D) funnel walls. These structures favor bacteria crossing funnels in one direction over the other, based on the surface interaction of individual swimmers. The funnels have been used to rectify the random motility of bacteria and thereby concentrate them. However, funnel walls have only been realized on surfaces, and have therefore not been deployed in liquid samples to date. The present disclosure leverages recent advances in the resolution of three-dimensional (3D) printing to develop three-dimensional micro-traps that rectify the motility of bacteria, and trap them into deployable, microscale particles.

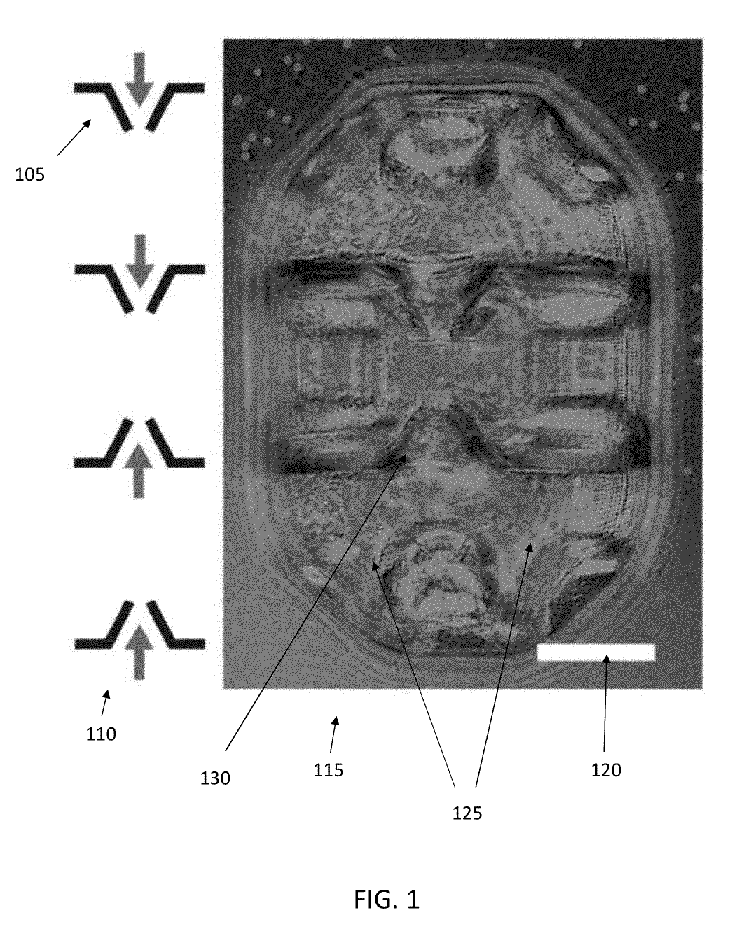

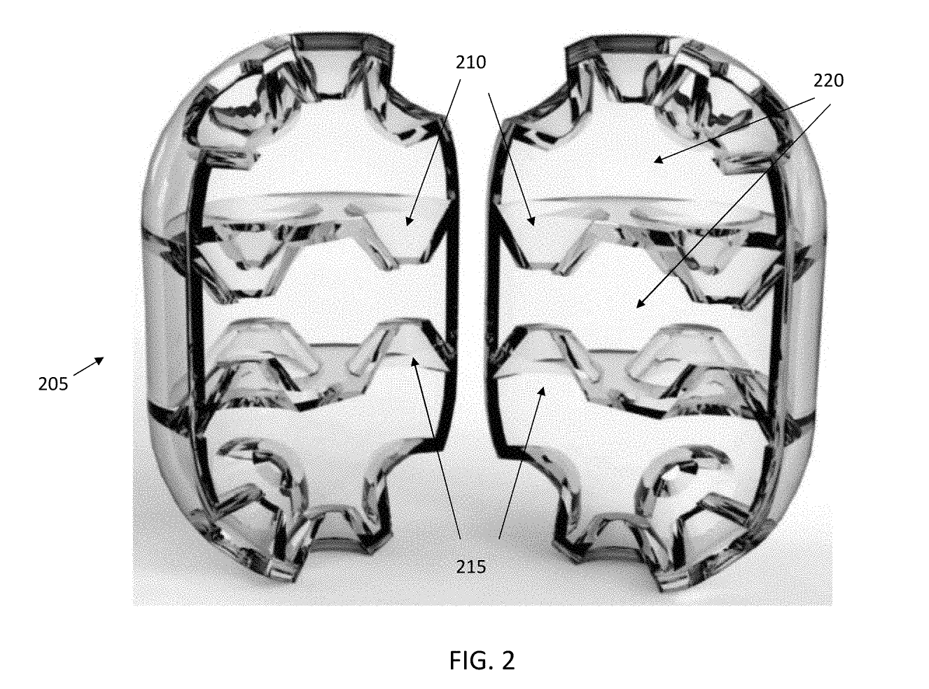

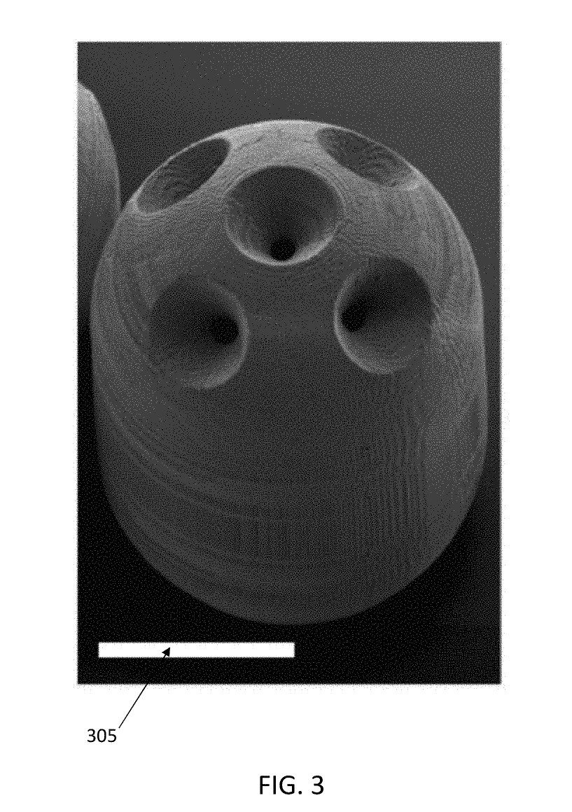

FIG. 1 illustrates an example of deployable micro-traps (105). For example, the microtraps may have a diameter of 150 μm and a height of 220 In this example, the microtraps are akin to miniaturized lobster pots that can sequester motile bacteria from a liquid suspension. FIG. 1 illustrates a cross-section schematic of the rectifying funnel apertures, with opposite orientations (105,110) and arrows illustrating the flow of liquid and of the motile bacteria. FIG. 1 also illustrates an optical microscopy image (115) of a micro-trap, with a scale bar (120) of 50 μm. The dots (125) are bacteria locations in the optical image (115), which is a frame extracted from a video. It can be noted that the funnels in the image are oriented similarly to the adjacent schematics: for example, funnel (130) is oriented like funnel (110). The particular shape of the microtrap in FIG. 1 is illustrated also in FIGS. 2-3.

FIG. 2 illustrates an exemplary embodiment of a microtrap comprising multiple funnels oriented in opposite directions. The liquid flows into the microtrap, though the funnels, and the bacteria is trapped within the microtrap passing through the funnels oriented inwardly, into the chamber. Alternatively, there is no liquid flow, but the motile bacteria swimming within the liquid pass through the funnels, thus entering the interior of the microtrap. As visible in FIG. 2, a micro-trap can comprise multiple chambers, stacked to produce an egg-shaped structure. FIG. 2 illustrates a 3D model of a micro-trap rendered in a semi-transparent material, and cut vertically into two halves to show the internal funnel structures. FIG. 2 illustrates funnels oriented in one direction (210) and in the opposite direction (215), though both are directed inwardly into the microtrap. The microtraps may comprise multiple chambers (220), with each wall separating the chambers comprising one or more funnels. In the example of FIG. 2, a central chamber is accessible through four top funnels and four bottom channels, while the top and bottom chambers are each accessible through five funnels from the liquid environment external to the microtrap. In some embodiments, the inner volume of the structure is 1.72 nL. In embodiments where the microtraps are shaped like an egg, the top and bottom outer surfaces have funnels oriented at an angle relative to the longitudinal axis of the microtrap, as visible in FIG. 2.

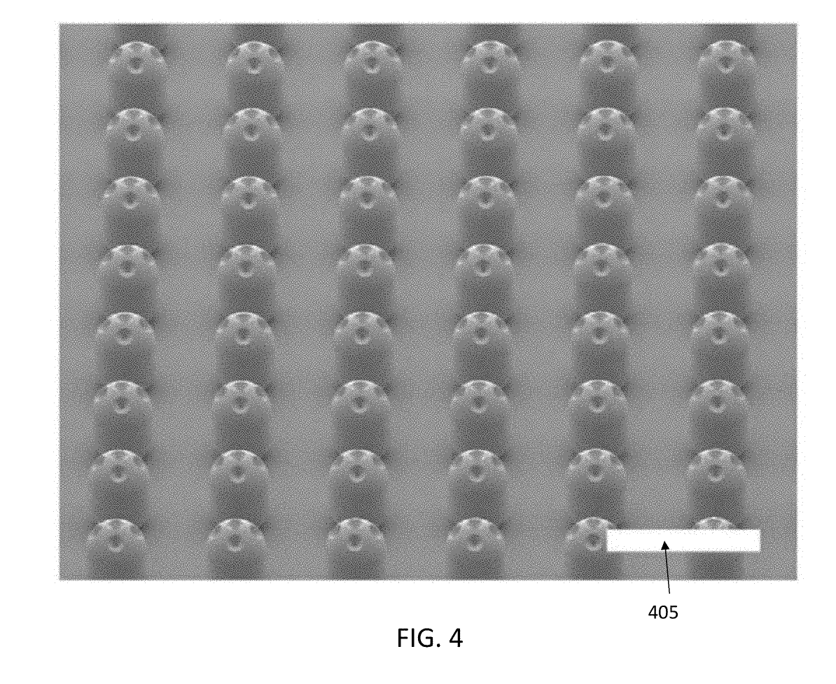

Funnel apertures connect inner chambers of the micro-traps with the outside liquid. FIG. 3 shows a scanning electron microscope (SEM) of a microtrap, with a scale bar of 80 micrometers. FIG. 4 illustrates an SEM picture of an array of microtraps on a glass substrate, fabricated using a 3D direct-laser-lithography system; the scale bar (405) is 500 micrometers. After fabrication, the micro-traps were detached from their support substrate and deployed in a bacterial suspension for testing.

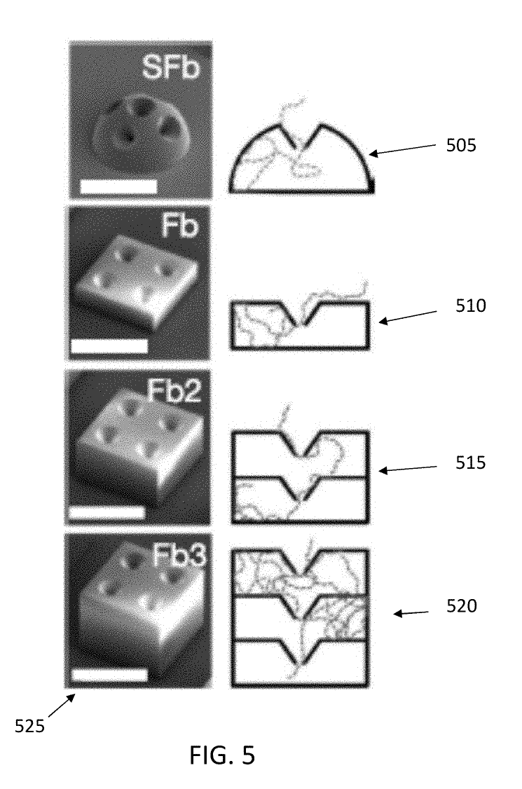

The surface-attached micro-traps were tested by imaging the accumulation of bacteria within the traps over time, for four different geometries as illustrated in FIG. 5: single domes (505), 1-layer boxes (510), 2-layer boxes (515), and 3-layer boxes (520), all with funnel-shaped apertures. The scale bars (525) in FIG. 5 are 100 micrometers. The square box structure (510) has dimensions of 150×150×50 micrometers, while the 4 funnel apertures have an external diameter of 45 micrometers, an internal diameter of 10 micrometers, and a length of 25 micrometers. These are exemplary dimensions and may be varied. The dome (505) has a diameter of 150 micrometers, and 5 funnels with an external diameter of 45 micrometers and an internal diameter of 10 micrometers. The wall thickness of all structures in FIG. 5 is 8 micrometers. Structures (515) and (520) have dimensions which are multiples of those of structure (510).

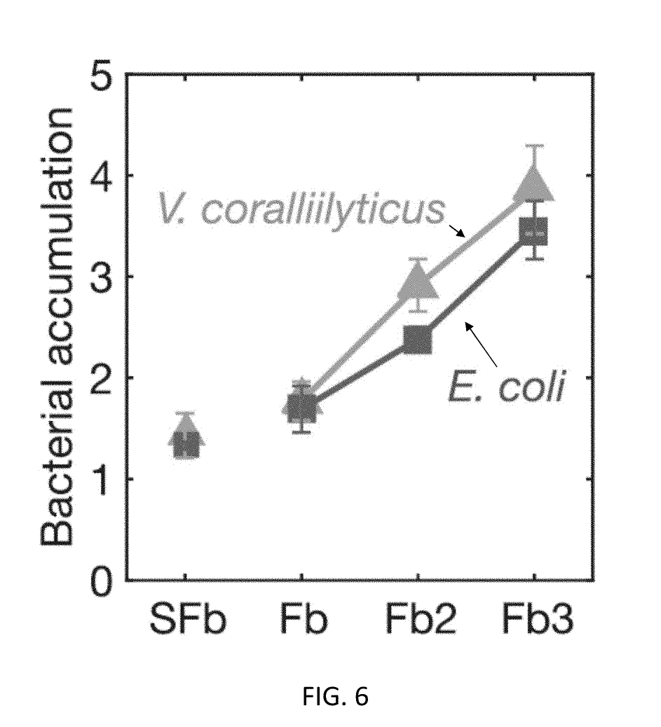

Experiments were conducted with two species of bacteria: the enteric bacterium Escherichia coli, which represents the classic model for bacterial motility, and the marine pathogen Vibrio coralhilyticus, which swims rapidly with a strategy that significantly differs from E. coli's. The concentration of bacteria inside the micro-traps was quantified by image analysis and compared with the concentration of bacteria in the external suspension, determined with the same approach. In all micro-traps, an accumulation of bacteria within the structure was detected, for both E. coli and V. coralhilyticus, demonstrating the ability of the micro-traps to trap swimming bacteria. FIG. 6 illustrates data for each of the structures of FIG. 5, for two bacteria.

The highest average accumulation (4-fold higher concentration of bacteria within the micro-traps than outside) was observed in the 3-layer micro-traps. Furthermore, the accumulation increased with the number of layers in the micro-trap: the 3-layer traps had approximately double the accumulation compared to the 1-layer box, demonstrating that the multi-layer design is effective in enhancing trapping. The increase in accumulation with increasing number of layers is also in agreement with earlier experiments with 2D arrays of funnels, described by Galajda, P., Keymer, J., Chaikin, P. & Austin, R., A wall of funnels concentrates swimming bacteria, J. Bacteriol. 189, 8704-7 (2007), the disclosure of which is incorporated herein by reference in its entirety.

The trapping mechanism is based on the interaction of motile bacteria with 3D funnel-like apertures, and relies on rectification and confinement. Upon approaching the micro-traps by random motility, bacteria preferentially swim along the surface of the funnels and—due to the funnel's shape—are directed through the funnel's aperture and into the inner chamber. The asymmetric shape of the funnels makes it less likelihood for a bacterium to swim out through the funnel in the reverse direction, resulting in an accumulation of cells inside the micro-trap. This effect is enhanced by the presence of multiple layers of funnels, which guide bacteria further into the interior of the micro-traps, and decreases the outward flux of bacteria. The funnels, therefore, establish an asymmetry in the random motion of bacteria, resulting in a preferential overall flow from outside the microtrap to within the microtrap.

The influence of micro-trap geometry on trapping efficiency was further investigated through a mathematical model. The model simulated 10⁵ bacterial trajectories for each geometry, and quantified the percentage of trapped bacteria at its steady state. It was found that funnel-like apertures accumulate 35% more bacteria than cylindrical apertures. Cylindrical apertures that form an acute angle with the micro-traps' internal walls, also trap bacteria due to their asymmetry toward the inside of the micro-traps. The predicted accumulation increased up to approximately 3-fold for the 3-layer micro-trap. These results show a good comparison with the experimental observations, and confirm that the mechanism of bacterial accumulation in the micro-traps is the rectification of bacterial motility due to surface interactions, a fundamental process likely applicable to all motile bacteria. Therefore, the microtraps mechanism of sequestering bacteria will be applicable to a wide range of microbial swimmers.

As further testing, micro-traps in a bacterial suspension to determine their ability to lower the bacterial load. The deployable micro-traps were designed by stacking a single dome on top of a 1-layer box, and mirroring this stack to obtain an egg-shaped particle. Thus the deployable structures are a combination of the building blocks tested in FIG. 5. Three hundred micro-traps were added to a 10 μL suspension of E. coli. The traps' total internal volume was 5% of the total suspension, and the volume displaced by the micro-traps was approximately 2%. Counting of bacteria revealed that the micro-traps progressively lowered the bacterial load in the suspension compared to the load in a simultaneous control, resulting in a 20% decrease after 20 min and a 60% decrease after 180 min.

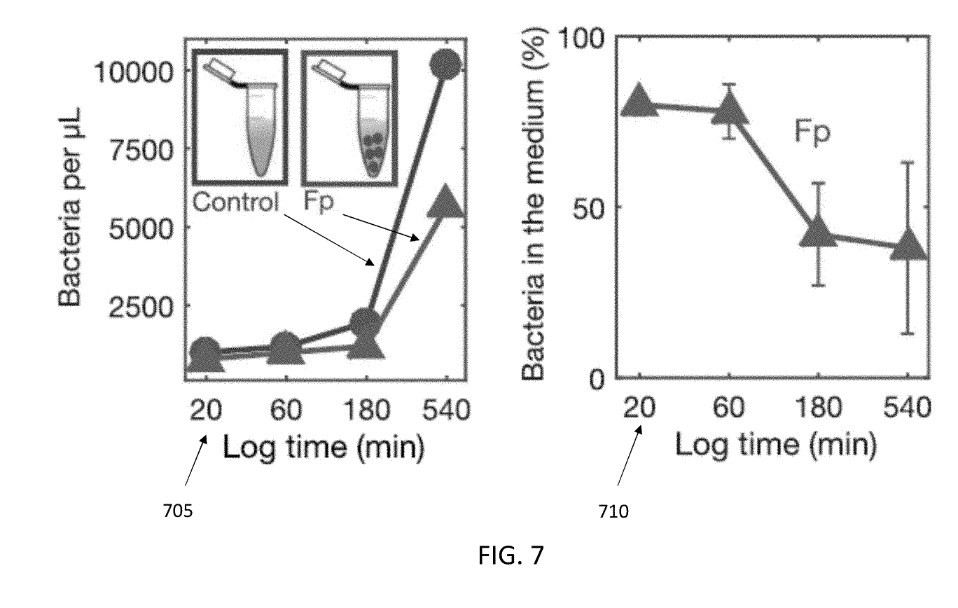

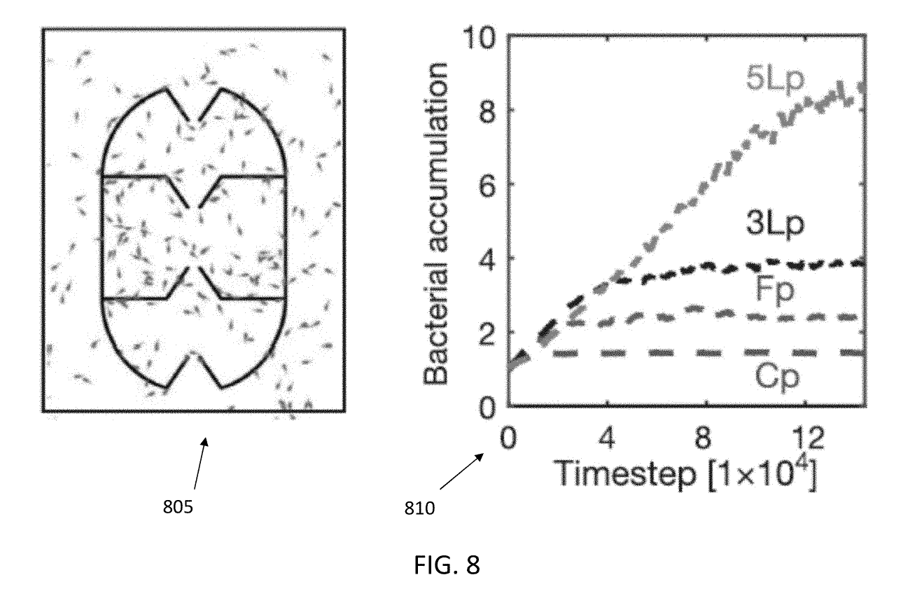

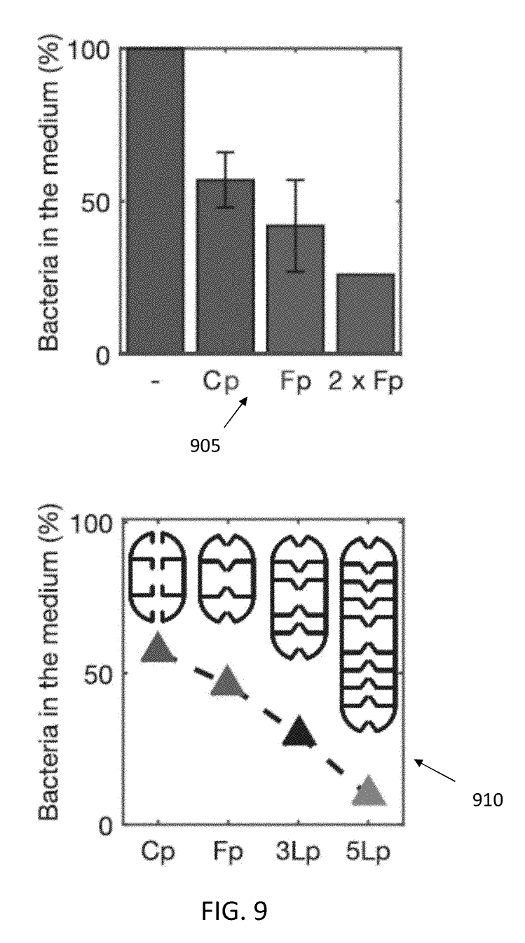

FIGS. 7-9 illustrate bacterial depletion with deployable micro-traps, from experiments (705,710,905) and numerical simulations (805,810,910): (805) illustrates the number of E. coli bacteria per μL present in a tube with 30 micro-traps (Fp) per μL as a function of time, as well as a control experiment without micro-traps; (810) illustrates the percentage of bacteria left in the suspending medium as a function of time, in the presence of 30 micro-traps (Fp) per μL (the error bars correspond to two independent experiments); (905) illustrates the percentage of bacteria left in the suspending medium after 180 minutes. In (905), the first bar is data for the tube without micro-traps; the Cp bar is for the tube with micro-traps having straight apertures, and concentration of 30 per μL (4 independent experiments); the Fp bar is for the tube with micro-traps having funnel apertures, and a concentration of 30 per μL (5 independent experiments); the 2×Fp bar is for the tube with micro-traps having funnel apertures, and a concentration of 60 per μL. In FIG. 8, (805) illustrates simulated bacterial distribution in the case of a micro-trap with funnel apertures and 2 layers (Fp), while (810) illustrates a time course of the accumulation obtained from numerical simulations of micro-traps with 2 internal layers (Cp, Fp), 3 internal layers (3Lp), and 5 internal layers (5Lp). In FIG. 9, (910) illustrates the maximum depletion reached for simulated micro-traps with 2 internal layers (Cp, Fp), 3 internal layers (3Lp), and 5 internal layers (5Lp).

It can be seen from FIG. 8 that, after approximately 180 min, the depletion of bacteria almost plateaued, owing to the competition between the flux of bacteria into the trap due to swimming rectification and the flux of bacteria out of the trap due to random motility. After 540 min, the reduction in bacterial load compared to samples not containing the micro-traps was ca. 70%, while the absolute concentration of bacteria was 4 times higher compared to that measured at 180 min, due to bacteria growth. The constant or higher depletion of bacteria regardless of their growth in number proves that trapping is a phenomenon independent from the absolute number of bacteria per unit volume in the 10³-10⁵ bacteria/μL range. Importantly, the bacterial depletion was due to trapping within the micro-traps, as adhesion to the traps' outer surface was observed as not being significant.

The depletion efficiency can be affected by both funnel geometry and number of micro-traps. Comparing the bacterial depletion (measured after 180 min and normalized by the no-trap control) effected by 300 micro-traps with either asymmetric cylindrical apertures or funnel-like apertures, showed that the latter were 22% more effective in depleting bacteria from the solution. This result indicates that funnel geometry is an important design factor that can be optimized, possibly in a species-specific manner, to achieve highest trapping efficiency in different applications. Doubling the number of micro-traps, from 300 to 600, resulted in a 15% increase in the bacterial depletion after 180 min, from 60% to 75%. This finding is in line with the theoretical limit obtained considering micro-traps acting independently: given that 300 micro-traps captured 60% of the bacteria, the additional 300 micro-traps were expected to capture 60% of the remaining 40% of bacteria, i.e. an additional 24% (still independent of the absolute number of bacteria).

The accumulation of bacteria cₘₜ inside the micro-traps was also estimated imposing the concentration of bacteria in the absence of micro-traps (control experiments) to be 1 everywhere in the volume. When introducing the micro-traps, the concentration inside them increases. Consequently, the concentration in the outside medium will be less than 1. It is possible to describe the higher concentration in the micro-traps as cₘₜ=Vₘₜ⁻¹(1−cₛ)+cₛ, where Vₘₜ is the internal volume fraction of the micro-traps with respect to the total volume and cₛ is the concentration of bacteria in the suspension outside the micro-traps. This calculation revealed an 18-fold accumulation of bacteria (at time 180 min) within the micro-traps, with respect to the concentration in the suspension. This value is larger than that measured in surface-immobilized micro-traps, probably due to the free motion of the deployed micro-traps in the suspension.

Two dimensional simulations of the deployable micro-traps were carried out to assess the effect of geometry on the depletion efficiency. In agreement with experiments, simulations showed that (i) the accumulation of bacteria in the micro-traps increases with time up to a plateau, and (ii) the accumulation was ˜22% higher for micro-traps with funnel apertures compared to cylindrical apertures. Absolute concentrations of trapped bacteria were higher in simulations than in experiments, likely due to the 2D nature of the simulations.

Simulations allowed to predict the effect of future increases in 3D printing resolution, which will permit further increases in the geometrical parameter most influential for trapping efficiency: the number of layers of the micro-traps. The plateau depletion values obtained from simulations have been normalized by the experimental depletion values of the cylindrical aperture micro-traps. The bacterial accumulation in micro-traps was compared with one, three and five internal layers and different aperture geometries. It was found that the depletion of bacteria in the solution increases with the number of layers, from 60% for 1 layer to 75% for 3 layers and 95% for 5 layers. The reason is that, with more layers, bacteria are ‘stashed away’ further into the micro-trap and the flux of bacteria out of the micro-trap by random motility decreases. While the precise numbers will be different in 3D compared to 2D, it can be expected that the increase of the number of layers will also contribute very significantly to the efficiency of 3D micro-traps, and that the systematic optimization of the traps' geometry will lead to yet more effective and faster accumulation. As the resolution of 3D printing improves, so will the possibilities for engineered microstructures that interact with microorganisms in controllable and potentially beneficial ways.

The present disclosure describes how deployable micro-traps can be fabricated in high-throughput and can considerably reduce the load of bacteria from a liquid suspension within tens of minutes. This approach uses a completely passive mechanism that does not require heating, chemical additions or large amounts of energy. The intrinsic selection process favoring the trapping of the most motile (hence, often, most virulent) bacteria is a considerable advantage of this method. The design of these structures can be guided by the extensive recent research focused on understanding microbial swimming and the interaction between microorganisms and surfaces, enabling the optimization of deployable microstructures and making their design species- and application-specific. This approach, in combination with continuing improvements in 3D micro-manufacturing, can reduce the number of micro-traps required to achieve the desired reduction in bacterial load, by optimizing multiple elements of micro-trap design, including funnel geometry and number of layers.

Micro-traps can represent an appealing alternative to the use of pharmacological agents, such as antibiotics, whose extensive use has created a well-known red-queen effect by driving the emergence of resistant strains. Micro-traps can also be used in synergy with antibiotics. For example, micro-traps could be loaded with antibiotics at resulting concentrations much lower than usually given in bulk—as the killing action will be localized inside the particles—and noxious effects of the antibiotics on the host are avoided. In this approach, rather than dosing antibiotics homogeneously everywhere, bacteria would swim into antibiotic-laden traps. The antibiotic traps can be further made more effective as well as potentially species-specific, by augmenting the antibiotic with chemo-attractants. These loading approaches can require the use of low-diffusivity compounds, or compounds partly trapped into a solid or gel matrix, to avoid diffusion severely limiting the time scale of micro-trap operation. In other words, the compounds should be reasonably confined to within the trap, for if they were to diffuse quickly to outside the trap, their efficacy would drop.

After use, the micro-traps can be removed from the liquid using large-pore filters (e.g., pore size of ˜100 μm), a cheap and fast filtering procedure. Therefore, micro-traps can be deployed in the gut of animals and patients, for example, for sampling. In this manner, 3D micro-technologies may open the road to a new “pharmacology”, not based on chemistry, but on the possibility to interfere mechanically with the dynamic properties of pathogens and other cells.

In some embodiments, the microtraps can be fabricated on substrates, using a semitransparent, negative tone photoresist as the building material. The polymerized resist is biocompatible, has a low density and a Young's module of 5 GPa. In some embodiments, the deployable micro-traps were 150×220 μm in size and had funnels with 45 μm and 10 μm diameter apertures, over a total length of 25 To remove them from the substrate, 20 μL of distilled water was cast on top of the produced arrays, and the micro-traps were gently scratched with a sterile steel inoculation loop, allowing them to float. The micro-traps were then collected and freed of possible production residues by washing them in 0.2 mL tubes containing 100 μL of ultrapure water. The water-filled tubes with micro-traps were exposed to 50 mBar vacuum for 5 minutes and then spun for few seconds. The procedure was repeated until all micro-traps precipitated. The supernatant was collected, and the micro-traps were dehydrated under vacuum (50 mBar) for 1 h. The micro-traps were then sterilized by exposing them to UV light for 30 minutes.

For the experiments on bacterial accumulation with dome-shaped and multiple-layer box-shaped micro-traps, a polydimethylsiloxane (PDMS) gasket was built around the bottom coverslip with the micro-traps attached. We added 50 μL of a bacterial suspension, and placed the samples in the testing apparatus. Since the volume of the bacterial suspension was much larger than the inner volume of each micro-trap, it was possible to quantify the accumulation of bacteria inside individual micro-traps while neglecting the depletion of bacteria in the outer medium, i.e., the micro-traps are considered immersed in an infinite bacterial suspension. To measure the accumulation of bacteria inside the microtraps, the bacteria was counted in a volume corresponding to an area of 40×40 μm and a height of 10 to 40 μm. The obtained value was compared with the number of bacteria in the same volume outside the structures at the same height from the bottom coverslip.

For the experiments on bacterial depletion with deployable micro-traps, nine μL of LB medium were added to the tubes containing the micro-traps. To make sure that the medium had penetrated inside the micro-traps, a 50 mBar vacuum was applied again for 5 minutes. Control samples followed the same procedure. In each tube, 1 μL of E. coli was inoculated, grown in 5 mL of LB at 37° C. up to a density of ˜0.7 OD₆₀₀. The tubes containing bacteria and micro-traps were mounted parallel to the surface on a vertically rotating wheel at ˜1.4 rpm at room temperature to avoid precipitation. At different time points (depending on the experiment), 2 μL of the supernatant from the respective samples were collected and the bacteria counted by optical microscopy in a micro-chamber slide. Five different areas of the micro-chamber for each sample were photographed and analyzed by software to determine the number of bacteria present. The counting method was validated with a separate experiment, where optical density (OD) readings were used as a reference. The correlation between the two measurement was linear with R²=0.93.

For the time course experiments, independent sets of micro-traps were used for each time point, and the corresponding control samples. Starting from a single culture of E. coli, bacteria were divided into 8 Eppendorf tubes, 4 containing Luria Broth (LB) medium, and 300 micro-traps each and 4 containing only LB medium. Each experiment was performed (together with its control) starting from an independent culture.

For the numerical simulations, a Langevin model was employed, previously validated also in the presence of flow, which captures the effect of the boundary on the swimming direction of bacteria close to the surface. To treat the interactions between bacteria and the surfaces of the micro-traps, when a bacterium arrives within 1 μm distance from a surface its incident angle was constrained to the surface to be 2.5 degrees, which was found to be the most stable angle for E. coli swimming near a surface. The swimming speed was set to 15 μm/s and the rotational diffusivity to 0.4 s−1, typical values for E. coli. The model was validated for the case of bacteria swimming between two parallel surfaces, by comparing the predicted accumulation of bacteria near the surfaces with the prior observations for E. coli.

Microtraps were tested with Vibrio coralliilyticus strain YB2 dsRed, grown in Marine Broth 2216, and Escherichia coli strains AW405 and JM109, grown in Luria Broth (LB) medium. The deployable micro-traps and boxes were fabricated using a commercial 3D direct-laser-lithography system. To carry out numerical modeling, the equations of motion were integrated numerically for 10⁵ simulated bacteria using a fourth-order Runge-Kutta scheme.

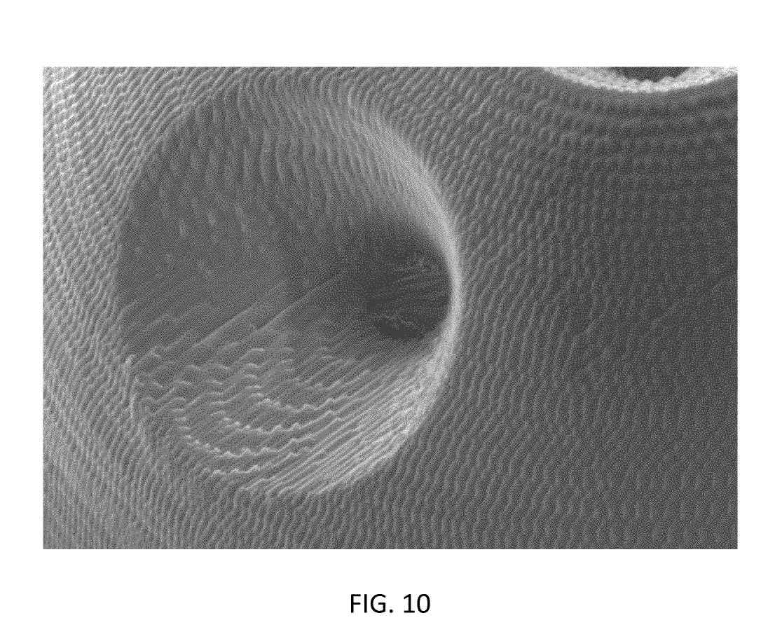

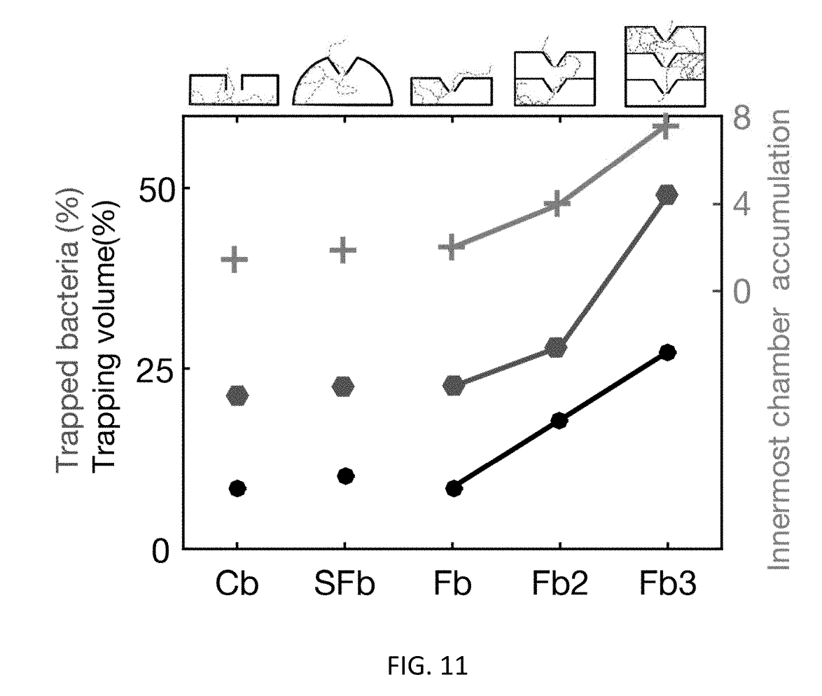

FIG. 10 illustrates a close up view of a funnel aperture. The external diameter, in this example, is 45 and the internal diameter is 10 μm (Fp). The height of the apertures in z-direction is 25 FIG. 11 illustrates a simulation of the trapping capabilities of the surface bound micro-traps. In accordance with experimental results, increasing the number of layers increases both maximum accumulation in the innermost chamber and the percentage of trapped bacteria. Moreover, the simulated result shows that the trapping is not linearly dependent on the trapping volume. A linear increase in trapping volume from 1 to 3 layers in a more than linear increase in trapped bacteria. The trapped bacteria and innermost chamber accumulation is plotted as a function of trap geometry. Additionally, the trapping volume fraction taken in the performed simulations is also plotted.

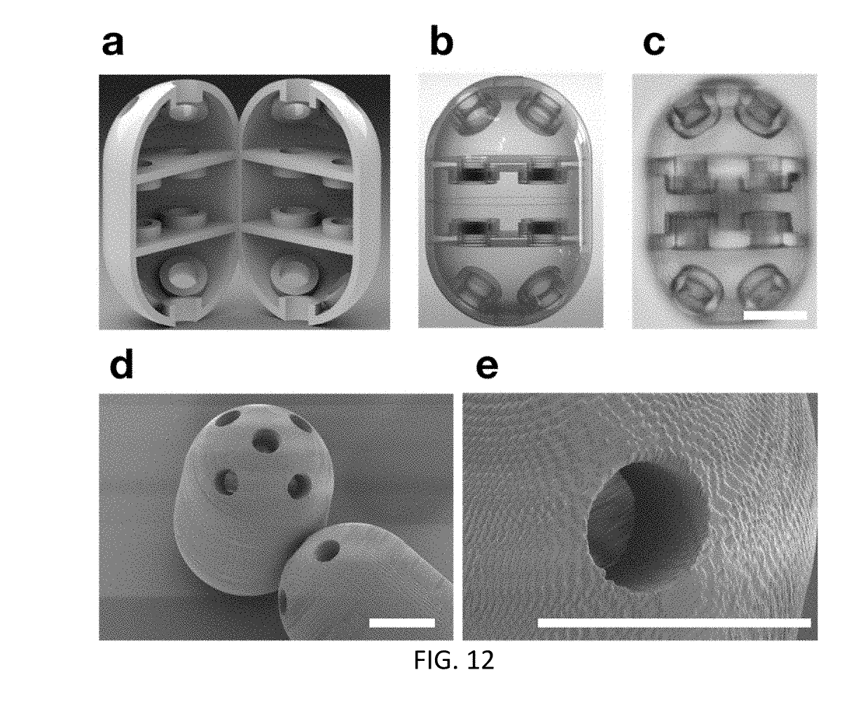

FIG. 12 shows the deployable micro-trap with cylindrical apertures (Cp). A computer rendering in transparent plastic material is shown in panel b next to an optical microscopy image of a realized micro-trap in panel c. An SEM picture is also shown in panel d (scale bar 50 μm) together with a detail of the cylindrical aperture in panel e (scale bar 50 μm). A CAD 3D model cut vertically into two halves is shown in panel a. The inner volume of the structures calculated from this CAD model was 1.64 nL.

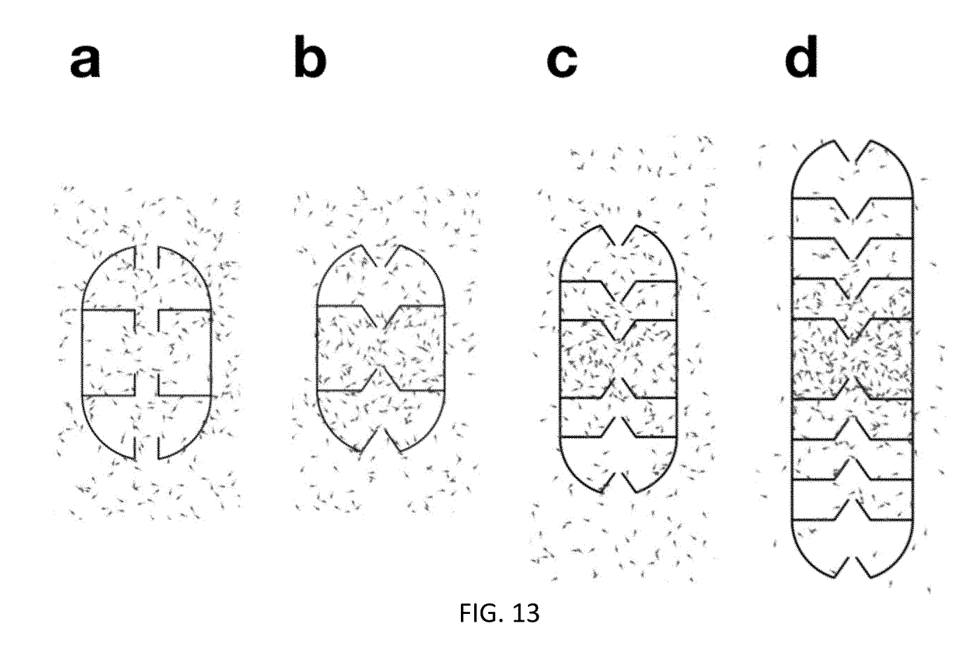

FIG. 13 illustrates numerical simulations of 2D cross-sections of deployable micro-traps with 2 (panels a and b), 3 (panel c) and 5 (panel d) layers. As discussed previously in the present disclosure, the Fp micro-traps show a higher accumulation in the inner layers compared to Cp micro-traps. By increasing the number of layers a further improvement of the accumulation is achieved. FIG. 14 illustrates: the bacterial distribution after 3000 seconds in the case of a micro-trap with cylindrical apertures and 2 layers (Cp) in panel a; the bacterial distribution after 3000 s in the case of a micro-trap with funnel apertures and 2 layers (Fp) in panel b; the bacterial distribution after 3000 s in the case of a micro-trap with funnel apertures and 3 layers (3Lp) in panel c; and the bacterial distribution after 6000 s in the case of a micro-trap with funnel apertures and 5 layers (5Lp) in panel d.

In some embodiments, the microtrap is made of a material impermeable to the liquid in which the microtrap is immersed, and impenetrable by the motile bacteria. In some embodiments, the microtrap comprises stacked chambers, as visible in FIG. 13, in that each chamber occupies a consecutive section, longitudinally, of the microtrap. In some embodiments, the microtrap is shaped like an egg. In some embodiments, the microtrap comprises two dome sections and a central cylindrical section: a top dome section, a central cylinder section, and a bottom dome section. In some embodiments, the microtrap comprises an outer surface, and inner surfaces or walls that separate inner chambers. All surfaces or walls have openings to allow entry of motile bacteria. As visible in FIG. 2, in some embodiments the microtrap comprises at least 18 openings.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A microtrap comprising:
an outer surface separating an inner volume of the microtrap from an outer volume; and
at least one opening allowing entry of motile bacteria from the outer volume into the inner volume.

2. The microtrap of claim 1, wherein the at least one opening comprises a plurality of openings.

3. The microtrap of claim 1, wherein the at least one opening is a funnel oriented towards the inner volume.

4. The microtrap of claim 1, wherein the microtrap comprises a plurality of chambers, each chamber of the plurality of chambers comprising a plurality of openings.

5. The microtrap of claim 1, wherein the microtrap is configured to be immersed in a liquid containing the motile bacteria, and the microtrap is made of a material impermeable to the liquid.

6. The microtrap of claim 1, wherein the microtrap comprises five stacked chambers, each chamber of the plurality of chambers comprising a plurality of openings.

7. The microtrap of claim 1, wherein the microtrap comprises a top dome section, a central cylinder section, and a bottom dome section.

8. The microtrap of claim 4, wherein at least one chamber of the plurality of chambers contains an antibiotic.

9. The microtrap of claim 8, wherein the antibiotic has low diffusivity.

10. The microtrap of claim 1, wherein the microtrap has a length of 220 μm and a width of 150 μm.

11. The microtrap of claim 3, wherein the funnel has a larger diameter of 45 μm and a smaller diameter of 10 μm.

12. The microtrap of claim 4, wherein the plurality of openings comprises at least 18 openings.
